(19) United States
(12) Patent Application Publication
(10) Pub. No.: US 2026/0303883 A1
(43) Pub. Date: Oct. 1, 2026

(54) STREAMING APPARATUS, STREAMING METHOD, AND STORAGE MEDIUM

(71) Applicant: HONDA MOTOR CO., LTD., Tokyo (JP)

(72) Inventor: Junichiro Onaka, Tokyo (JP)

(21) Appl. No.: 19/548,267

(22) Filed: Feb. 24, 2026

(30) Foreign Application Priority Data
Mar. 28, 2025 (JP) 2025-056380

(51) Int. Cl. H04N 21/2343; H04N 21/2187; H04N 21/258; H04N 21/2743; H04N 21/414

(52) U.S. Cl. CPC H04N 21/2343; H04N 21/2187; H04N 21/25825; H04N 21/2743; H04N 21/41407

(57) ABSTRACT

A streaming server that: acquires user identification information included in a streaming request and device information; when a plurality of pieces of device information are associated with the acquired user identification information, determines whether the plurality of pieces of device information include device information of a first display device and a second display device; and when the device information of the first display device and the second display device is included, select a second display mode from among a first display mode being a display mode of the first display device and the second display mode being a display mode of the second display device, and stream a streaming image corresponding to the streaming request to the first display device or the second display device so that the display mode corresponds to the selected second display mode.

### INCORPORATION BY REFERENCE

The present application claims priority under 35 U.S.C. § 119 to Japanese Patent Application No. 2025-056380 filed on Mar. 28, 2025. The content of the application is incorporated herein by reference in its entirety.

### BACKGROUND OF THE INVENTION

### Field of the Invention

The present invention relates to a streaming apparatus, a streaming method, and a storage medium.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users.

For example, a method is conceivable of viewing a moving image streamed by a streamer of a video, without a person in a vulnerable position personally having to enter a mobile body to access a transportation system. By viewing the moving image streamed by the streamer, it is possible to experience the feeling of going out or traveling.

International Publication No. WO 2017/138143 discloses a terminal apparatus including a sharing unit that shares a screen displayed in a first screen resolution with a head-mounted display in a second screen resolution lower than the first screen resolution, and a display part that displays the screen shared by the sharing unit. When detecting a specific usage situation, this terminal apparatus configures the head-mounted display using first resolution information for the sharing unit to perform sharing in the first screen resolution.

However, there is room for improvement in user-friendliness when a streaming image streamed from a streaming server is also transferred to another display device and viewed on a plurality of display devices.

The present invention was made in view of the above-described circumstances and has an object to enhance user-friendliness for viewers viewing the streaming image when viewing the streaming image on a plurality of display devices. Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

A streaming apparatus according to an aspect of the present disclosure includes: a communication unit configured to receive a streaming request; a storage unit configured to store, in association with each other, user identification information for identifying a user and device information for identifying a display device used by the user; and a control section configured to: generate a streaming image based on a captured image received from a streamer terminal; acquire user identification information included in the streaming request and device information; when a plurality of pieces of the device information are associated with the acquired user identification information, determine whether the plurality of pieces of device information include device information of a first display device being a head-mounted device and a second display device not being the head-mounted device; and when the plurality of pieces of device information include the device information of the first display device and the second display device, select a second display mode from among a first display mode being a display mode of the first display device and the second display mode being a display mode of the second display device, and stream the streaming image corresponding to the streaming request to the first display device or the second display device corresponding to the acquired device information so that the display mode corresponds to the selected second display mode.

According to the present disclosure, when display devices associated with the user identification information included in the streaming request include the first display device and the second display device, the second display mode is selected and the streaming image corresponding to the streaming request is streamed to the first display device or the second display device so that the display mode corresponds to the selected second display mode. Accordingly, it is possible to improve user-friendliness when the streaming image streamed from the streaming server is transferred to another display device and viewed on a plurality of display devices.

### BRIEF DESCRIPTION OF THE DRAWINGS

FIG. 1 is a diagram showing a system configuration of a streaming system;

FIG. 2 is a block diagram showing a configuration of an in-vehicle apparatus and a streaming server;

FIG. 3 is a diagram showing a configuration of a user registration database;

FIG. 4 is a diagram showing a configuration of a stream management database;

FIG. 5 is a block diagram showing a configuration of a streamer apparatus;

FIG. 6 is a block diagram showing a configuration of a first display device;

FIG. 7 is a block diagram showing a configuration of a second display device;

FIG. 8 is a flowchart showing a first operation of the streaming server; and

FIG. 9 is a flowchart showing a second operation of the streaming server; and

FIG. 10 is a flowchart showing an operation of the first display device.

### DETAILED DESCRIPTION OF THE INVENTION

Hereinafter, an embodiment of the present invention will be described with reference to the drawings.

### Embodiment

### [1. Configuration of Streaming System]

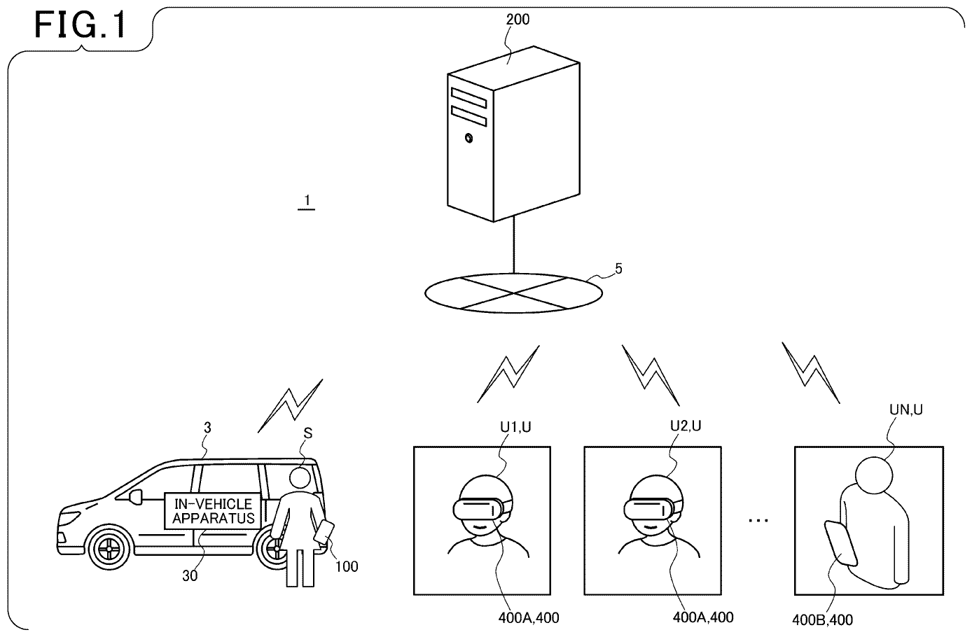

FIG. 1 is a diagram showing a system configuration of a streaming system 1.

The streaming system 1 includes an in-vehicle apparatus 30, a streamer terminal 100 used by a streamer S, a streaming server 200, and a display device 400 used by a viewer U. The streaming system 1 is a system for live streaming content including an image captured by the streamer terminal 100.

Live streaming refers to an activity in which a streamer and an unspecified viewer participate, and an image based on a capturing result from the streamer terminal 100 is streamed in real-time to the display device 400. The image may be a still image or a moving image.

The in-vehicle apparatus 30 is installed in a vehicle 3 and is wirelessly connected via short-range wireless communication or the like to the streamer terminal 100 possessed by the streamer S being a passenger of the vehicle 3.

The in-vehicle apparatus 30 receives, from the streamer terminal 100, content data including an images captured by a camera included in the streamer terminal 100 and speech input via a microphone included in the streamer terminal 100. The in-vehicle apparatus 30 uploads the received content data to the streaming server 200.

The streamer terminal 100 may be a smartphone or tablet personal computer (PC), or may be a camera such as a digital camera or a 360-degree camera capable of capturing an entire surrounding area. In this case, the microphone and the camera may be implemented separately.

The streaming server 200 stores the content received from the in-vehicle apparatus 30 in a server storage unit. The streaming server 200 streams the uploaded content data to the display device 400 of the viewer U. Live streaming technology can be realized using known technology such as HTTP Live Streaming (HLS), Common Media Application Format (CMAF), Web Real-Time Communication (WebRTC), or Real-Time Messaging Protocol (RTMP).

The display device 400 is a terminal apparatus possessed by the viewer U that watches the content data streamed from the streaming server 200. FIG. 1 shows U1, U2, . . . , UN viewers U as the viewer U. N is an arbitrary natural number. FIG. 1 shows, as the display device 400, a head-mounted first display device 400A worn on the head by viewers U1 and U2, and a second display device 400B possessed by a viewer UN.

The display device 400 includes the first display device 400A and the second display device 400B. The first display device 400A is a head-mounted display device in which an image display part displaying an image is mounted on the head of the viewer U. The first display device 400A may be transmissive or non-transmissive, as long as the content streamed from the streaming server 200 can be viewed.

The second display device 400B is a non-head-mounted display device in which an image display part is not mounted on the head of viewer U. For example, the first display device 400A may be a portable or mobile terminal apparatus such as a smartphone, tablet PC, or notebook PC, or may be a stationary terminal apparatus such as a desktop PC.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### [2. Configuration of In-Vehicle Apparatus]

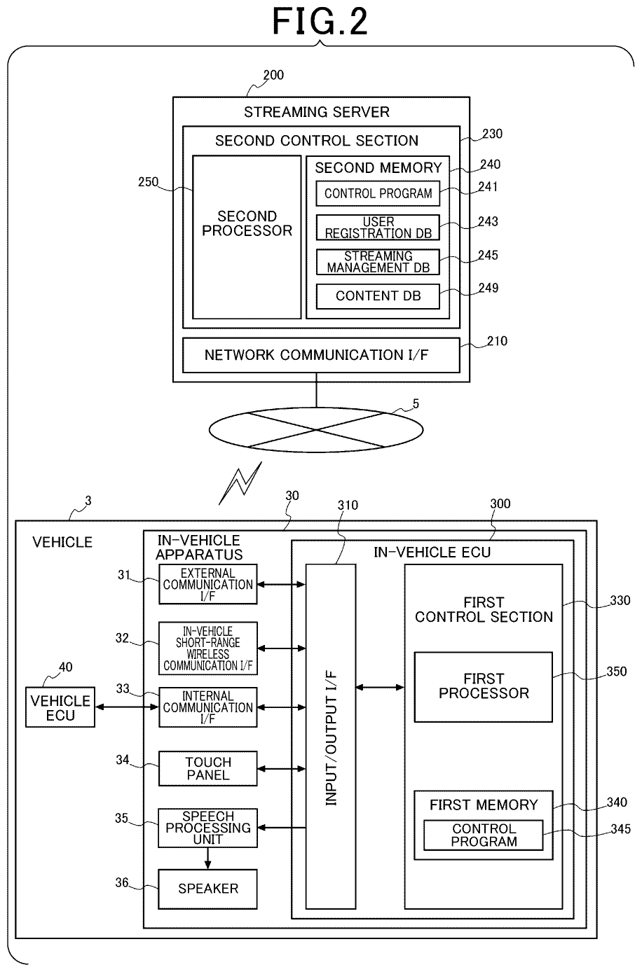

FIG. 2 is a diagram showing a configuration of the in-vehicle apparatus 30 and the streaming server 200.

First, the configuration of the in-vehicle apparatus 30 will be described with reference to FIG. 2.

The in-vehicle apparatus 30 includes an external communication interface 31, an in-vehicle short-range wireless communication interface 32, an internal communication interface 33, a touch panel 34, a speech processing unit 35, a speaker 36, and an in-vehicle electronic control unit (ECU) 300. Hereinafter, interface will be abbreviated as I/F.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 200.

For example, the in-vehicle short-range wireless communication I/F 32 is a communication module that performs communication in accordance with a near-field communication (NFC) standard such as Bluetooth (registered trademark) or Wi-Fi. The in-vehicle short-range wireless communication I/F 32 performs short-range wireless communication with a terminal apparatus possessed by a passenger and receives an image, speech, and the like captured by the terminal apparatus.

The internal communication I/F 33 is an input/output interface connected to an in-vehicle network (not shown). For example, a communication bus supporting a communication standard such as controller area network (CAN), CAN with Flexible Data-Rate (CAN FD), or Ethernet (registered trademark) is used for the in-vehicle network. The internal communication I/F 33 performs mutual data communication via the in-vehicle network with in-vehicle equipment such as a vehicle ECU 40 or another relay apparatus.

The touch panel 34 includes a display panel such as a liquid-crystal panel or an electroluminescent (EL) panel, and a touch sensor. The touch sensor detects a touch operation by the streamer S on the touch panel 34 and outputs position information indicating a position of the detected touch operation to a first control section 330.

For example, the speech processing unit 35 includes a processor and converts digital speech data output by the first control section 330 into an analog speech signal. The speech processing unit 35 amplifies the converted analog speech signal and outputs the amplified speech signal via the speaker 36.

The in-vehicle ECU 300 includes an input/output I/F 310 and the first control section 330.

The input/output I/F 310 functions as a connection unit between the first control section 330 and the external communication I/F 31, the in-vehicle short-range wireless communication I/F 32, the internal communication I/F 33, the touch panel 34, and the speech processing unit 35. The input/output I/F 310 includes a connector and an interface circuit. The input/output I/F 310 outputs data input from the external communication I/F 31, the in-vehicle short-range wireless communication I/F 32, the internal communication I/F 33, the touch panel 34, and the speech processing unit 35 to the first control section 330. The input/output I/F 310 outputs data input from the first control section 330 to the external communication I/F 31, the in-vehicle short-range wireless communication I/F 32, the internal communication I/F 33, the touch panel 34, or the speech processing unit 35.

The first control section 330 is a computer apparatus including a first memory 340 and a first processor 350.

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350, configuration data that defines an operation of the in-vehicle apparatus 30, and the like.

The first processor 350 is, for example, an arithmetic processing apparatus such as a central processing unit (CPU) or a microprocessing unit (MPU). The first processor 350 may be implemented as a single processor or as a plurality of processors. The first processor 350 may be implemented as a system on a chip (SoC) integrated with part or all of the first memory 340, or with another circuit.

The in-vehicle ECU 300 receives a captured image, speech, and the like from the streamer terminal 100, and uploads the received captured image, speech, and the like to the streaming server 200.

### [3. Configuration of Streaming Server]

Next, the configuration of the streaming server 200 will be described.

The streaming server 200 includes a network communication I/F 210 and a second control section 230.

For example, the network communication I/F 210 includes a communication card such as a network interface card (NIC), and performs mutual data communication via the communication network 5 with the in-vehicle apparatus 30, the streamer terminal 100, and the display device 400. The network communication I/F 210 corresponds to a streaming apparatus communication unit.

The second control section 230 is a computer apparatus including a second memory 240 and a second processor 250.

The second memory 240 includes, for example, a volatile semiconductor memory and a non-volatile semiconductor memory. The second memory 240 may include only a non-volatile semiconductor memory. The second memory 240 may include an auxiliary storage apparatus such as a hard disk drive (HDD) or an SSD.

The second memory 240 stores a control program 241 executed by the second processor 250, a user registration database 243, a stream management database 245, and a content database 247. Hereinafter, database will be abbreviated as DB.

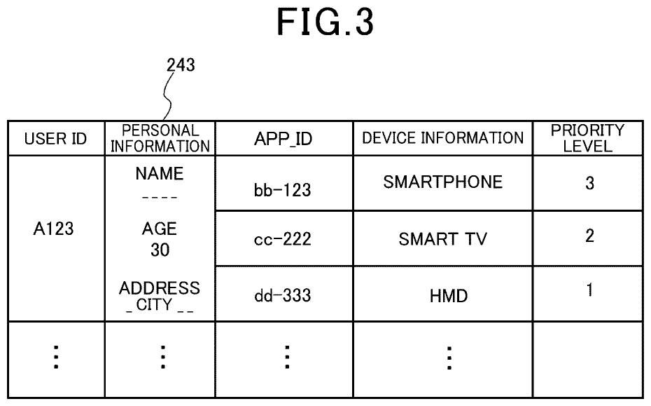

FIG. 3 is a diagram showing a configuration of the user registration DB 243.

One record in the user registration DB 243 includes a user ID, personal information of a user, APP_ID, device information, and priority level information. APP is an abbreviation of application program. The priority level information is information indicating a level indicating a priority degree.

The user ID is identification information for identifying a user utilizing an image streaming service provided by the streaming server 200. The user includes the streamer S and the viewer U.

The personal information is personal information of the streamer S and the viewer U being the user. The personal information includes, for example, information such as name, address, sex, and age.

APP_ID is identification information for identifying the application program downloaded and installed on the streamer terminal 100 or the display device 400.

The streamer S and the viewer U download the APP from a predetermined website and respectively install the APP on the streamer terminal 100 and the display device 400.

The device information is information indicating whether the display device 400 on which the APP indicated by APP_ID is installed is the first display device 400A or the second display device 400B. That is, the device information is information indicating whether the display device 400 is a head-mounted display apparatus, or an apparatus other than the head-mounted display apparatus such as a smartphone, a tablet PC, or a notebook PC.

When a plurality of pieces of device information are registered in association with the same user ID, the priority level information is information indicating a priority level of the display device 400 corresponding to this plurality of pieces of device information. The priority level information is information necessary when display device 400 transfers a streaming image streamed from the streaming server 200 to another display device 400 associated with the same user ID through mirroring. The streaming server 200 compares a priority level of a display device 400 being a transmission source of a streaming request with a priority level of another display device 400 to which this display device 400 transfers the streaming image, and streams the streaming image in accordance with a display mode of the display device 400 with a higher priority level.

Display modes include the first display mode corresponding to the first display device 400A and a second display mode corresponding to the second display device 400B. The first display mode and the second display mode will be described in detail below.

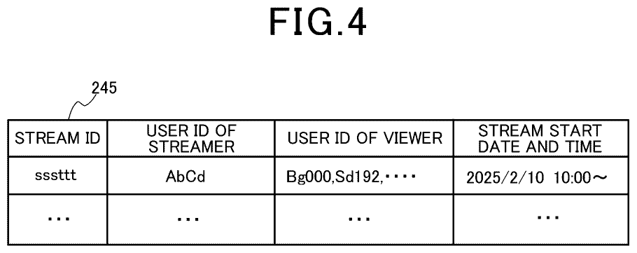

FIG. 4 is a diagram showing a configuration of the stream management DB 245.

One record in the stream management DB 245 includes a stream ID for identifying a stream, the user ID of the streamer S, the user ID of the viewer U, and a stream start date and time.

Returning to FIG. 2, the configuration of the streaming server 200 will be described further.

The second processor 250 is, for example, an arithmetic processing apparatus such as a CPU or an MPU. The second processor 250 may be implemented as a single processor or as a plurality of processors. The second processor 250 may be implemented as an SoC integrated with part or all of the second memory 240, or with another circuit.

The second control section 230 registers, in a content DB 249, content data including a streaming image and speech uploaded from the streamer terminal 100. Upon receiving a streaming request, the second control section 230 reads the content data specified by the received streaming request from the content DB 249 and streams the read content data to the display device 400 being the origin of the streaming request.

### [4. Configuration of Streamer Terminal]

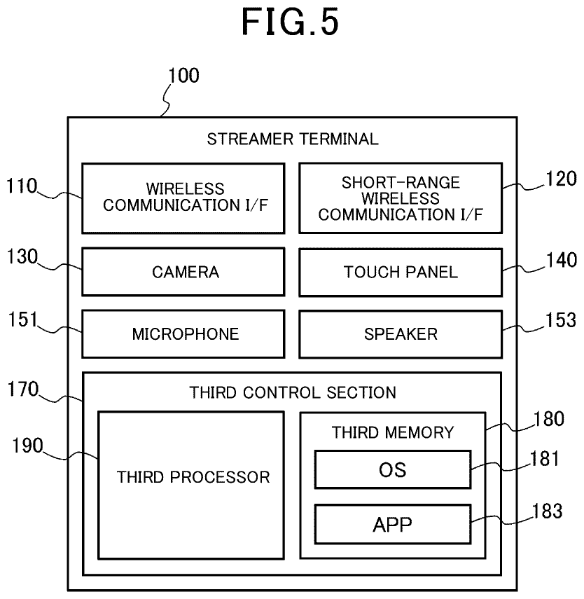

FIG. 5 is a block diagram showing a configuration of the streamer terminal 100.

The streamer terminal 100 includes a wireless communication I/F 110, a short-range wireless communication I/F 120, a camera 130, a touch panel 140, a microphone 151, a speaker 153, and a third control section 170.

The wireless communication I/F 110 is a communication module that performs wireless communication in accordance with a mobile communication standard such as LTE, 4G, 5G, or Wi-Fi. The wireless communication I/F 110 is connected to the communication network 5 via an antenna (not shown) and performs mutual data transmission/reception with the streaming server 200.

For example, the short-range wireless communication I/F 120 is a communication module that performs communication in accordance with an NFC standard such as Bluetooth or Wi-Fi. The short-range wireless communication I/F 120 transmits a captured image captured by the camera 130, speech input via the microphone 151, and the like to the in-vehicle apparatus 30 through short-range wireless communication with the in-vehicle apparatus 30.

The camera 130 is a capturing apparatus including an image sensor and a data processing circuit. The image sensor is implemented as, for example, a charge-coupled device (CCD) or a complementary metal-oxide-semiconductor (CMOS). The data processing circuit generates a captured image from an output of the image sensor. The captured image generated by the camera 130 is transmitted to the in-vehicle apparatus 30 under the control of the third control section 170.

The touch panel 140 includes a display panel such as a liquid-crystal panel or an EL panel, and a touch sensor. The touch panel 140 functions as a display part for displaying an image and as a reception part for accepting an operation by the streamer S.

The microphone 151 is a speech input apparatus for inputting speech of the streamer S, and the speaker 153 is a speech output apparatus for outputting speech of the viewer U and the like.

The third control section 170 is a computer apparatus including a third memory 180 and a third processor 190.

The third memory 180 includes a non-volatile semiconductor memory. The third memory 180 may include an auxiliary storage apparatus such as an SD card. The third memory 180 stores control programs such as an operating system (OS) 181 and an APP 183. The APP 183 is an application program that performs mutual data communication with the streaming server 200, displays a moving image included in content streamed by the streaming server 200 on the touch panel 140, and outputs speech included in the content to the speaker 153.

The third processor 190 is, for example, an arithmetic processing apparatus such as a CPU or an MPU. The third processor 190 may be implemented as a single processor or as a plurality of processors.

### [5. Configuration of Display Device]

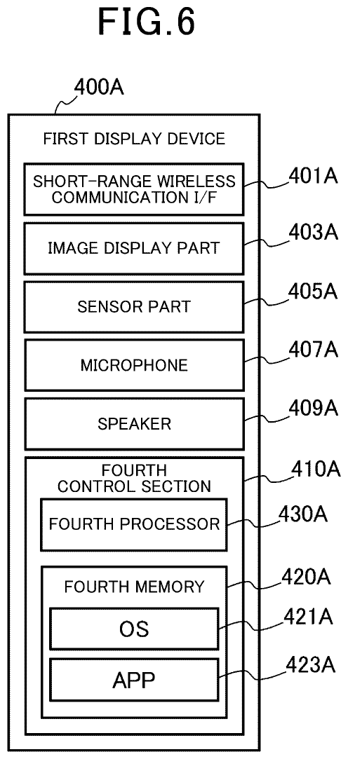

FIG. 6 is a block diagram showing a configuration of the first display device 400A.

The first display device 400A includes a short-range wireless communication I/F 401A, an image display part 403A, a sensor part 405A, and a fourth control section 410A.

For example, the short-range wireless communication I/F 401A is a communication module that performs communication in accordance with an NFC standard such as Bluetooth or Wi-Fi. The short-range wireless communication I/F 401A can be wirelessly connected to the communication network 5 via a Wi-Fi router (not shown) installed in the home or the like of the viewer U. The short-range wireless communication I/F 401A corresponds to a device communication unit.

The image display part 403A includes a display panel (not shown) such as a liquid-crystal panel or an organic EL panel, a light guide plate that emits image light emitted from the display panel toward the eyes of viewer U, and the like. The image display part 403A is mounted on the head of viewer U.

For example, the sensor part 405A is installed in the image display part 403A and detects movement of the head of the viewer U. The sensor part 405A is, for example, a motion sensor including a three-axis accelerometer and a three-axis gyroscope. The sensor part 405A may include a three-axis magnetometer. In this case, the sensor part 405A may be an inertial measurement unit (IMU) in which the three-axis accelerometer, the three-axis gyroscope, and the three-axis magnetometer are modularized.

A microphone 407A collects the speech emitted by the viewer U, and a speaker 409A outputs the speech.

The fourth control section 410A is a computer apparatus including a fourth memory 420A and a fourth processor 430A.

The fourth memory 420A includes a non-volatile semiconductor memory. The fourth memory 420A may include a volatile semiconductor memory and a non-volatile semiconductor memory. The fourth memory 420A stores an OS 421A and an APP 423A. The APP 423A is an application program that performs mutual data communication with the streaming server 200, displays a moving image included in content streamed by the streaming server 200 on the image display part 403A, and outputs speech included in the content to the speaker 153.

The fourth processor 430A is, for example, an arithmetic processing apparatus such as a CPU or an MPU. The fourth processor 430A may be implemented as a single processor or as a plurality of processors.

The viewer U operates the display device 400 and boots the APP 423A to, for example, access a web page provided by the streaming server 200 and select the channel and the program the viewer U wants to watch from among programs offered by the streaming server 200. The viewer U selects whether to transfer and display the content streamed from the streaming server 200 to another display device 400 through mirroring. When transferring and displaying the content to another display device 400, the viewer U selects the display device 400 to be used as a transfer destination. When the viewer U selects a channel and a program, the presence or absence of mirroring, and the display device 400 as the transfer destination, the fourth control section 410A of the display device 400 transmits a streaming request including the user ID, APP_ID, the channel information, the program information, and mirroring information to the streaming server 200. The mirroring information includes information indicating the presence or absence of mirroring, and device information or APP_ID of the display device 400 being a mirroring partner when mirroring is present.

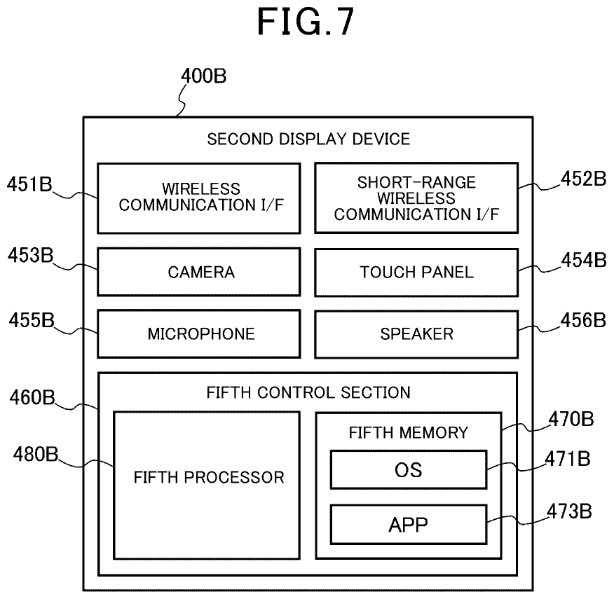

FIG. 7 is a block diagram showing a configuration of the second display device 400B.

The second display device 400B shown in FIG. 7 includes a wireless communication I/F 451B, a short-range wireless communication I/F 452B, a camera 453B, a touch panel 454B, a microphone 455B, a speaker 456B, and a fifth control section 460B. Since the configuration of the second display device 400B is identical to the configuration of the streamer terminal 100 shown in FIG. 5, description thereof will be omitted.

### [6. Operation of Streaming Server]

Next, an operation of the streaming server 200 will be described.

The second control section 230 receives a streaming request from the display device 400. The streaming request includes the user ID, APP_ID, the channel information, the program information, and the mirroring information.

APP_ID is information indicating the APP installed on the display device 400 being the transmission source of this streaming request.

The mirroring information is information indicating whether to transfer the streaming image streamed from the streaming server 200 to another display device 400 associated with the same user ID through mirroring. When the mirroring information indicating that mirroring is present, the streaming request includes the device information or APP_ID of the display device 400 being the mirroring partner.

The second control section 230 determines a priority level of the display device 400 being the origin of the received streaming request, that is, the display device 400 having transmitted the streaming request to the streaming server 200, and a priority level of the display device 400 being the transfer destination of the streaming image through mirroring.

For example, assume that the display device 400 being the origin of the streaming request is the first display device 400A and the display device 400 being the transfer destination of the streaming image is the second display device 400B.

When the priority level of the first display device 400A is higher than the priority level of the second display device 400B, the second control section 230 streams the streaming image to the first display device 400A in accordance with the display mode of the first display device 400A. When the priority level of the second display device 400B is higher than the priority level of the first display device 400A, the second control section 230 streams the streaming image to the first display device 400A in accordance with the display mode of the second display device 400B.

Display modes include the first display mode corresponding to the first display device 400A and a second display mode corresponding to the second display device 400B.

The first display mode is a display mode corresponding to the first display device 400A being a head-mounted display apparatus.

The first display mode is a mode in which a range of a captured image to be streamed as the streaming image is changed in accordance with movement of the head of a user on which the first display device 400A is mounted.

When the display mode is the first display mode, the second control section 230 continuously receives sensor data indicating the movement of the head of the user from the first display device 400A. The second control section 230 calculates, based on the sensor data received from the first display device 400A, a rotation direction in which the head of the user rotates and a movement amount of the rotation direction. The second control section 230 changes a range to be cropped from the captured image as the streaming image, based on the calculated rotation direction of the head and the rotation amount.

For example, when the user rotates their head to the right, the second control section 230 moves the range to be cropped from the captured image to the right by a movement amount corresponding to the identified rotation amount of the head.

When the user rotates their head to the left, the second control section 230 moves the range to be cropped from the captured image to the left by a movement amount corresponding to the identified rotation amount of the head.

The second display mode is a display mode corresponding to the second display device 400B not being a head-mounted display apparatus. The second display mode is a display mode in which a rendered range of the streaming image to be streamed to the second display device 400B is not changed. When the display mode is the second display mode, the second control section 230 crops at all times a certain range of the captured image uploaded from the in-vehicle apparatus 30 and streams the cropped image as the streaming image to the display device 400.

The priority level information registered in the user registration DB 243 can be changed using setting change information received from the display device 400.

For example, when the display device 400 is the first display device 400A, the first display device 400A accepts an operation on an operation panel such as a touch pad (not shown) included in the first display device 400A and generates the setting change information based on the accepted operation. The first display device 400A transmits the generated setting change information to the streaming server 200.

When the display device 400 is the second display device 400B, the second display device 400B accepts an operation performed by the viewer U on a remote control (not shown), the touch panel 454B, or the like and generates the setting change information based on the accepted operation. The second display device 400B transmits the generated setting change information to the streaming server 200.

Assume that the streaming server 200 streams the streaming image to the first display device 400A in the second display mode, and the first display device 400A transfers the content to the second display device 400B through mirroring. When the wireless connection to the second display device 400B is lost and the streaming of the streaming image to the second display device 400B is ended, the first display device 400A transmits a disconnection notification to the streaming server 200 indicating that the connection to the second display device 400B has been lost. Upon receiving the disconnection notification, the second control section 230 changes the display mode of the streaming image streamed to the first display device 400A from the second display mode to the first display mode.

It is also possible to register setting information including the priority levels in the user registration DB 243 in advance.

For example, when the user has not set the priority level for a plurality of display devices 400, the display mode to be selected as default may be registered in advance as the setting information. When a plurality of pieces of device information are registered in association with one user ID, the second control section 230 may determine the priority levels based on device types indicated by this plurality of pieces of device information and store the priority levels in the second memory 240 as the setting information. When the device information associated with the user ID included in the streaming request includes a display device 400 other than the first display device 400A, the setting information may be configured so as to perform display in the second display mode.

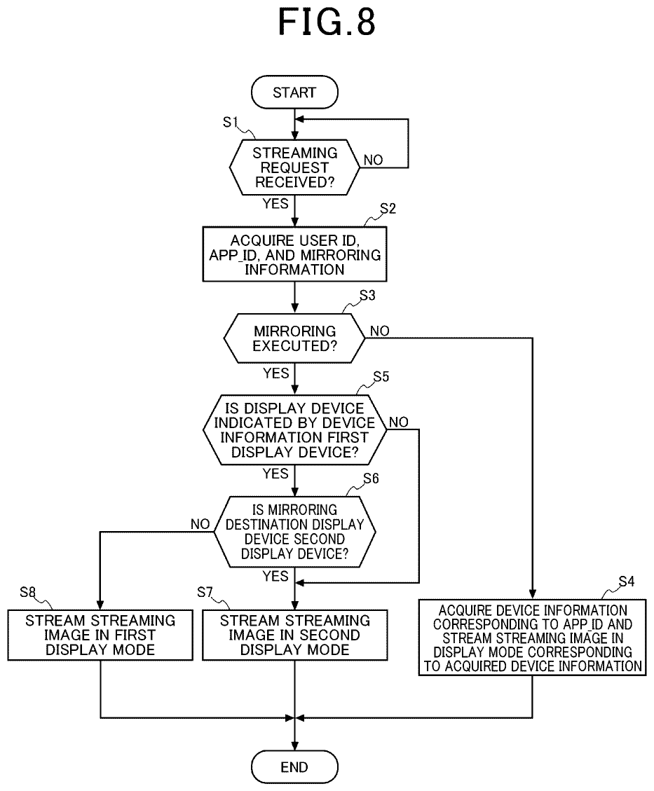

FIG. 8 is a flowchart showing a first operation of the streaming server 200.

The first operation of the streaming server 200 will be described with reference to the flowchart shown in FIG. 8.

First, the second control section 230 determines whether a streaming request has been received (step S1).

When a streaming request has not been received (NO in step S1), the second control section 230 stands by until a streaming request is received.

Upon receiving a streaming request (YES in step S1), the second control section 230 acquires a user ID, APP_ID, and mirroring information included in the received streaming request (step S2). The second control section 230 determines, based on the acquired mirroring information, whether a display device 400 being an origin of the streaming request executes mirroring to another display device 400 (step S3).

Upon determining that the display device 400 being the origin of the streaming request does not execute mirroring (NO in step S3), the second control section 230 acquires the device information corresponding to acquired APP_ID from the user registration DB 243. The second control section 230 streams the streaming image in a display mode corresponding to the acquired device information (step S4). That is, the second control section 230 streams the streaming image in the first display mode when the acquired device information indicates the first display device 400A and streams the streaming image in the second display mode when the acquired device information indicates the second display device 400B.

Upon determining that mirroring is executed (YES in step S3), the second control section 230 determines whether the display device indicated by the device information corresponding to acquired APP_ID is the first display device 400A (step S5). When the device information corresponding to APP_ID does not indicate the first display device 400A (NO in step S5), the second control section 230 streams the streaming image to the second display device 400B corresponding to the device information in the second display mode (step S7). That is, since the display device 400 to which the streaming image is streamed includes the second display device 400B, the streaming server 200 streams the streaming image in the second display mode being the display mode of the second display device 400B.

When the device information corresponding to APP_ID indicates the first display device 400A (YES in step S5), the second control section 230 determines whether a display device 400 being a mirroring destination is the second display device 400B (step S6).

When the display device 400 being the mirroring destination is the second display device 400B (YES in step S6), the second control section 230 streams the streaming image to the first display device 400A corresponding to the device information in the second display mode (step S7). Since the display device 400 to which the streaming image is streamed includes the second display device 400B, the streaming server 200 streams the streaming image in the second display mode being the display mode of the second display device 400B.

When the display device 400 being the mirroring destination is the first display device 400A (NO in step S6), the second control section 230 streams the streaming image to the first display device 400A corresponding to the device information in the first display mode (step S8).

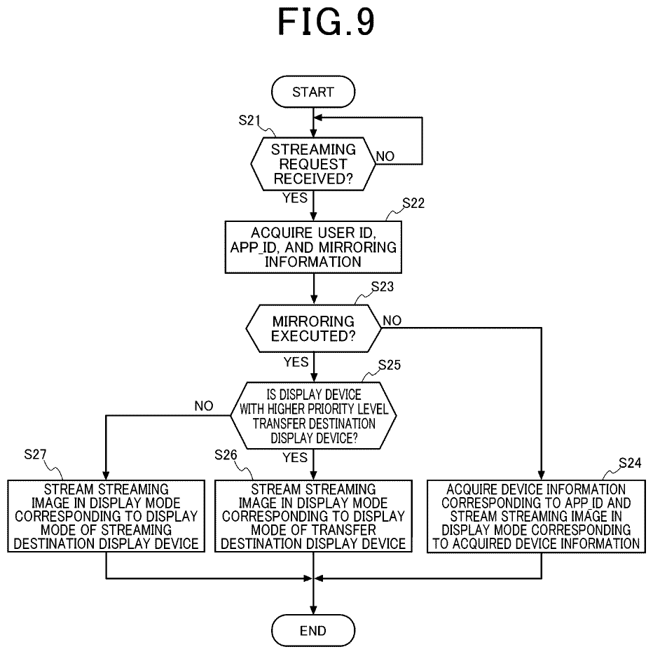

FIG. 9 is a flowchart showing a second operation of the streaming server 200.

The second operation of the streaming server 200 will be described with reference to the flowchart shown in FIG. 9. Note that since an operation from step S21 to step S24 is the same as the first operation shown in FIG. 8, description thereof is omitted.

Upon determining that mirroring is executed using the mirroring information (YES in step S23), the second control section 230 refers to the user registration DB 243 and compares a priority level of a streaming destination display device 400 to which the streaming server 200 streams the streaming image and a priority level of a transfer destination display device 400 to which this display device 400 transfers the streaming image (step S24).

When the display device 400 with a higher priority level is the transfer destination display device 400 (YES in step S25), the second control section 230 streams the streaming image to the streaming destination display device 400 in the display mode corresponding to the transfer destination display device 400 (step S26).

When the display device 400 with a higher priority level is the streaming destination display device 400 (NO in step S25), the second control section 230 streams the streaming image to the streaming destination display device 400 in the display mode corresponding to the streaming destination display device 400 (step S27).

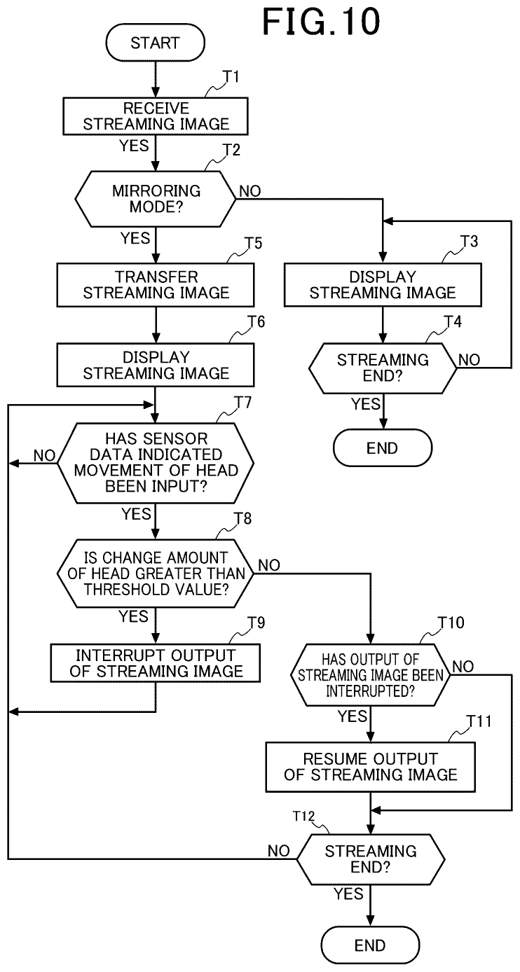

FIG. 10 is a flowchart showing an operation of the first display device 400A.

The operation of the first display device 400A will be described with reference to the flowchart shown in FIG. 10.

The flowchart shown in FIG. 10 is a flowchart showing the operation in which the streaming server 200 streams a streaming image to the first display device 400A in the first display mode and the first display device 400A transfers the streaming image to the second display device 400B in a mirroring mode.

First, the fourth control section 410A of the first display device 400A determines whether a streaming image has been streamed from the streaming server 200 (step T1). When a streaming image has not been received (NO in step T1), the fourth control section 410A stands by until a streaming image is received.

Upon receiving a streaming image (YES in step T1), the fourth control section 410A determines whether the first display device 400A is set to the mirroring mode (step T2). When the mirroring mode has not been set (NO in step T2), the fourth control section 410A displays the received streaming image on the image display part 403A (step T3). Subsequently, the fourth control section 410A determines whether streaming of the streaming image has ended (step T4). When the streaming of the streaming image has not ended (NO in step T4), the fourth control section 410A returns to step T3 and displays the streaming image received from the streaming server 200 on the image display part 403A. When the streaming of the streaming image ends (YES in step T4), the fourth control section 410A ends this processing flow.

When the first display device 400A has been set to the mirroring mode (YES in step T2), the fourth control section 410A transfers the received streaming image to the second display device 400B being a transfer destination (step T5) and displays the received streaming image on the image display part 403A (step T6).

Next, the fourth control section 410A determines whether sensor data indicating movement of the head of the viewer U has been input from the sensor part 405A (step T7). When sensor data has not been input (NO in step T7), the fourth control section 410A returns to the processing of step T1.

Upon receiving sensor data (YES in step T7), the fourth control section 410A determines whether a change amount of the movement of the head of the viewer U is greater than a threshold value, based on the input sensor data (step T8).

When the change amount of the movement of the head of the viewer U is greater than the threshold value (YES in step T8), the fourth control section 410A interrupts the transferring of the streaming image to the second display device 400B (step T9). Since the transferring of the streaming image from the first display device 400A has been interrupted, the second display device 400B blacks out the display of the touch panel 454B.

When the change amount of the movement of the head of the viewer U is smaller than or equal to the threshold value (NO in step T8), the fourth control section 410A determines whether the transferring of the streaming image to the second display device 400B has been interrupted (step T10).

When the transferring of the streaming image to the second display device 400B has been interrupted (YES in step T10), the fourth control section 410A resumes the transferring of the streaming image to the second display device 400B (step T11). Subsequently, the fourth control section 410A determines whether image streaming from the streaming server 200 has ended (step T12). When the transferring of the streaming image to the second display device 400B has not been interrupted (NO in step T10), the fourth control section 410A determines whether the image streaming from the streaming server 200 has ended (step T12).

When the image streaming from the streaming server 200 has not ended (NO in step T12), the fourth control section 410A returns to the determining of step T7. When the image streaming from the streaming server 200 ends (YES in step T12), the fourth control section 410A ends this processing flow.

### [7. Variations]

The above-described embodiment is a preferred embodiment of the present invention. However, the present invention is not limited to the above-described embodiment, and various modifications may be made without departing from the spirit of the present invention.

For example, the processing units in the flowcharts shown in FIGS. 8 and 9 are divided in accordance with their main processing content to facilitate understanding of the processing performed by the streaming server 200. The present invention is not limited by the manner in which the processing units in the flowcharts of FIGS. 8 and 9 are divided or by the names assigned to those processing units. The processing performed by the streaming server 200 can be divided into a greater number of processing units in accordance with the processing content, or can be divided so that one processing unit includes a greater amount of processing. The order of the processing in the above flowcharts is not limited to the examples shown in the figures. The same applies to the flowchart showing the operation of the first display device 400A shown in FIG. 10.

In the above-described embodiment, a case has been described in which the streaming server 200 streams the streaming image to the first display device 400A, but the streaming server 200 may stream the streaming image to the first display device 400A and the second display device 400B. In this case as well, the first display device 400A transmits the movement information indicating the movement of the head of the user to the streaming server 200, and the streaming server 200 determines the range of the image to be streamed as the streaming image from the captured image based on the movement information received from the first display device 400A.

For example, in the above-described embodiment, a case has been described in which an inside of the vehicle 3 is captured by one streamer terminal 100, but a plurality of streamer terminals 100 may be installed in the vehicle 3 and the inside of the vehicle 3 may be captured by this plurality of streamer terminals 100.

In the above-described embodiment, a configuration is shown in which the streamer terminal 100 and the in-vehicle apparatus 30 are connected via short-range wireless communication and the captured image is transmitted from the streamer terminal 100 to the in-vehicle apparatus 30, but the streamer terminal 100 may upload the captured image to the streaming server 200 and the streaming server 200 may upload the captured image to the in-vehicle apparatus 30. The streamer S visually recognizes a preview image of the captured image displayed on the touch panel 34 of the in-vehicle apparatus 30 and adjusts an angle of view of the streamer terminal 100 being a capturing apparatus.

In the above-described embodiment, a case has been described in which the captured image taken by the streamer terminal 100 is transmitted to the streaming server 200 by the in-vehicle apparatus 30, but the streamer terminal 100 may transmit the captured image taken by the streamer terminal 100 to the streaming server 200.

### [8. Configurations Supported by the Above-Described Embodiment]

The above embodiment is a specific example of the following configurations.

### (Configuration 1)

A streaming apparatus including: a communication unit configured to receive a streaming request; a storage unit configured to store, in association with each other, user identification information for identifying a user and device information for identifying a display device used by the user; and a control section configured to: generate a streaming image based on a captured image received from a streamer terminal; acquire user identification information included in the streaming request and device information; when a plurality of pieces of the device information are associated with the acquired user identification information, determine whether the plurality of pieces of device information include device information of a first display device being a head-mounted device and a second display device not being the head-mounted device; and when the plurality of pieces of device information include the device information of the first display device and the second display device, select a second display mode from among a first display mode being a display mode of the first display device and the second display mode being a display mode of the second display device, and stream the streaming image corresponding to the streaming request to the first display device or the second display device so that the display mode corresponds to the selected second display mode.

The streaming apparatus of configuration 1 can improve user-friendliness when the streaming image streamed from the streaming server is transferred to another display device and viewed on a plurality of display devices, since the second display mode is selected, and the streaming image corresponding to the streaming request is streamed to the first display device or the second display device so that the display mode corresponds to the selected second display mode, when the plurality of pieces of device information are associated with the user identification information and when the first display device and the second display device are included in this plurality of pieces of device information.

### (Configuration 2)

The streaming apparatus according to configuration 1, wherein when the plurality of pieces of device information include the device information of the first display device and the second display device, the control section streams the streaming image to the first display device or the second display device corresponding to the acquired device information in the display mode of the second display device in which a rendered range of the streaming image to be used as the streaming image is not changed.

According to the streaming apparatus of configuration 2, when the plurality of pieces of device information include the device information of the first display device and the second display device, the streaming image is streamed to the first display device or the second display device in the display mode of the second display device in which the rendered range of the streaming image to be used as the streaming image is not changed. Accordingly, it is possible to reduce dizziness experienced by the viewer viewing the streaming image, since the rendered range of the streaming image to be used as the streaming image is not changed.

### (Configuration 3)

The streaming apparatus according to configuration 1, wherein the storage unit stores setting information relating to a display mode of the display device, and when selecting the first display mode as the display mode in accordance with the setting information, the control section receives movement information indicating movement of a head of a user on which the first display device is mounted from the first display device, generates the streaming image based on the received movement information, and streams the generated streaming image to the first display device or the second display device.

The streaming apparatus of configuration 3 receives the movement information indicating the movement of the head of the user on which the first display device is mounted from the first display device, generates the streaming image based on the received movement information, and streams the generated streaming image. Accordingly, it is possible to stream the streaming image in accordance with the movement of the head of the user on which the first display device is mounted.

### (Configuration 4)

The streaming apparatus according to configuration 3, wherein the setting information includes priority degree information of a plurality of the display devices associated with the same user identification information, when the plurality of pieces of device information include the device information of the first display device and the second display device, the control section streams the streaming image in accordance with a display mode of a display device with a higher priority degree as indicated by the priority degree information, the priority degree information is set so that a priority degree of the second display device is higher than a priority degree of the first display device, and the second display mode is a display mode in which a rendered range of the streaming image to be used as the streaming image is not changed.

The streaming apparatus of configuration 4 streams the streaming image in accordance with the display mode of the display device with a higher priority degree as indicated by the priority degree information, when the plurality of pieces of device information include the device information of the first display device and the second display device. The priority degree information is set so that the priority degree of the second display device is higher than the priority degree of the first display device. Accordingly, when the plurality of pieces of device information include the device information of the first display device and the second display device, the streaming image is streamed in the display mode of the second display device in which the rendered range of the streaming image is not changed. Accordingly, it is possible to reduce dizziness caused by viewing the streaming image experienced by the viewer viewing the streaming image, since the range of the captured image to be used as the streaming image is not changed.

### (Configuration 5)

The streaming apparatus according to configuration 4, wherein the control section changes the priority degree information stored by the storage unit in accordance with operation information received from at least one of the first display device and the second display device.

According to the streaming apparatus of configuration 5, the priority degree information stored by the storage unit is changed in accordance with the operation information received from at least one of the first display device and the second display device. Accordingly, user-friendliness can be enhanced, since the priority degree information stored by the storage unit can be changed.

### (Configuration 6)

The streaming apparatus according to configuration 3, wherein when the streaming image is streamed to the first display device and the streaming image received by the first display device is not transferred to the second display device, the control section streams the streaming image in accordance with the first display mode of the first display device.

The streaming apparatus of configuration 6 streams the streaming image in accordance with the first display mode of the first display device, when the streaming image received by the first display device from the streaming apparatus is not transferred to the second display device. Accordingly, it is possible to display the image in the range corresponding to the movement of the head of the user on which the first display device is mounted as the streaming image, when the viewer does not view the streaming image on the second display device.

### (Configuration 7)

The streaming apparatus according to configuration 3, wherein the control section: receives the movement information indicating the movement of the head of the user on which the first display device is mounted from the first display device, when the display mode is determined as the first display mode in accordance with the setting information, the streaming image is streamed to the first display device, and the first display device transfers the streaming image to the second display device, or when the streaming image is streamed to the first display device and the second display device; streams the streaming image to the first display device, or to the first display device and the second display device, when the movement of the head of the user indicated by the received movement information is smaller than or equal to a predetermined value; and stops streaming the streaming image to the first display device, or to the first display device and the second display device, when the movement of the head of the user indicated by the movement information is greater than the predetermined value.

The streaming apparatus of configuration 7 receives the movement information indicating the movement of the head of the user from the first display device when the streaming image is streamed to the first display device in the first display mode and the first display device transfers the streaming image to the second display device or when the streaming image is streamed to the first display device and the second display device, and streams the streaming image to the first display device, or to the first display device and the second display device when the movement of the head of the user indicated by the received movement information is smaller than or equal to the predetermined value. The streaming of the streaming image to the first display device, or to the first display device and the second display device is stopped when the movement of the head of the user indicated by the movement information is greater than the predetermined value. Accordingly, it is possible to suppress dizziness caused by viewing the streaming image experienced by the viewer viewing the streaming image on the second display device.

### (Configuration 8)

A streaming method performed by a computer installed in a streaming apparatus including a communication unit and a storage unit configured to store, in association with each other, user identification information for identifying a user and device information for identifying a display device used by the user, the streaming method including: generating a streaming image based on a captured image received from a streamer terminal; receiving a streaming request; acquiring user identification information included in the streaming request and device information; when a plurality of pieces of the device information are associated with the acquired user identification information, determining whether the plurality of pieces of device information include device information of a first display device being a head-mounted device and a second display device not being the head-mounted device; and selecting a second display mode from among a first display mode being a display mode of the first display device and the second display mode being a display mode of the second display device, and streaming the streaming image corresponding to the streaming request to the first display device or the second display device corresponding to the acquired device information so that the display mode corresponds to the selected second display mode.

According to the streaming method of configuration 8, it is possible to achieve the same effects as the streaming apparatus of configuration 1.

### (Configuration 9)

A non-transitory computer-readable storage medium storing a program for causing a processor installed in a streaming apparatus including a communication unit and a storage unit configured to store, in association with each other, user identification information for identifying a user and device information for identifying a display device used by the user, to execute: processing of generating a streaming image based on a captured image received from a streamer terminal; processing of receiving a streaming request; processing of acquiring user identification information included in the streaming request and device information; when a plurality of pieces of the device information are associated with the acquired user identification information, processing of determining whether the plurality of pieces of device information include device information of a first display device being a head-mounted device and a second display device not being the head-mounted device; and processing of selecting a second display mode from among a first display mode being a display mode of the first display device and the second display mode being a display mode of the second display device, and streaming the streaming image corresponding to the streaming request to the first display device or the second display device corresponding to the acquired device information so that the display mode corresponds to the selected second display mode.

According to the program of configuration 9, it is possible to achieve the same effects as the streaming apparatus of configuration 1.

### Reference Signs List

1 streaming system
3 vehicle
5 communication network
5 network
30 in-vehicle apparatus
31 external communication interface
32 in-vehicle short-range wireless communication interface
33 internal communication interface
34 touch panel
35 speech processing unit
36 speaker
40 vehicle ECU
100 streamer terminal
110 wireless communication I/F
120 short-range wireless communication I/F
130 camera
140 touch panel
151 microphone
153 speaker
170 third control section
180 third memory
181 OS
183 APP
190 third processor
200 streaming server
210 network communication I/F
230 second control section
240 second memory
241 control program
243 user registration database
245 stream management database
247 content database
250 second processor
300 in-vehicle ECU
310 input/output I/F
330 first control section
340 first memory
345 control program
350 first processor
400A first display device
400B second display device
401A short-range wireless communication I/F
403A image display part
405A sensor part
407A microphone
409A speaker
410A fourth control section
420A fourth memory
421A OS
423A APP
430A fourth processor
451B wireless communication I/F
452B short-range wireless communication I/F
453B camera
454B touch panel
455B microphone
456B speaker
460B fifth control section

1. A streaming apparatus comprising:
a communication unit configured to receive a streaming request;
a storage unit configured to store, in association with each other, user identification information for identifying a user and device information for identifying a display device used by the user; and
a control section configured to:
generate a streaming image based on a captured image received from a streamer terminal;
acquire user identification information included in the streaming request and device information;
when a plurality of pieces of the device information are associated with the acquired user identification information, determine whether the plurality of pieces of device information include device information of a first display device being a head-mounted device and a second display device not being the head-mounted device; and
when the plurality of pieces of device information include the device information of the first display device and the second display device, select a second display mode from among a first display mode being a display mode of the first display device and the second display mode being a display mode of the second display device, and stream the streaming image corresponding to the streaming request to the first display device or the second display device so that the display mode corresponds to the selected second display mode.

2. The streaming apparatus according to claim 1, wherein
when the plurality of pieces of device information include the device information of the first display device and the second display device, the control section streams the streaming image to the first display device or the second display device corresponding to the acquired device information in the display mode of the second display device in which a rendered range of the streaming image to be used as the streaming image is not changed.

3. The streaming apparatus according to claim 1, wherein
the storage unit stores setting information relating to a display mode of the display device, and
when selecting the first display mode as the display mode in accordance with the setting information, the control section receives movement information indicating movement of a head of a user on which the first display device is mounted from the first display device, generates the streaming image based on the received movement information, and streams the generated streaming image to the first display device or the second display device.

4. The streaming apparatus according to claim 3, wherein
the setting information includes priority degree information of a plurality of the display devices associated with the same user identification information,
when the plurality of pieces of device information include the device information of the first display device and the second display device, the control section streams the streaming image in accordance with a display mode of a display device with a higher priority degree as indicated by the priority degree information,
the priority degree information is set so that a priority degree of the second display device is higher than a priority degree of the first display device, and
the second display mode is a display mode in which a rendered range of the streaming image to be used as the streaming image is not changed.

5. The streaming apparatus according to claim 4, wherein
the control section changes the priority degree information stored by the storage unit in accordance with operation information received from at least one of the first display device and the second display device.

6. The streaming apparatus according to claim 3, wherein
when the streaming image is streamed to the first display device and the streaming image received by the first display device is not transferred to the second display device, the control section streams the streaming image in accordance with the first display mode of the first display device.

7. The streaming apparatus according to claim 3, wherein
the control section:
receives the movement information indicating the movement of the head of the user on which the first display device is mounted from the first display device, when the display mode is determined as the first display mode in accordance with the setting information, the streaming image is streamed to the first display device, and the first display device transfers the streaming image to the second display device, or when the streaming image is streamed to the first display device and the second display device;
streams the streaming image to the first display device, or to the first display device and the second display device, when the movement of the head of the user indicated by the received movement information is smaller than or equal to a predetermined value; and
stops streaming the streaming image to the first display device, or to the first display device and the second display device, when the movement of the head of the user indicated by the movement information is greater than the predetermined value.

8. A streaming method performed by a computer installed in a streaming apparatus including a communication unit and a storage unit configured to store, in association with each other, user identification information for identifying a user and device information for identifying a display device used by the user, the streaming method comprising:
generating a streaming image based on a captured image received from a streamer terminal;
receiving a streaming request;
acquiring user identification information included in the streaming request and device information;
when a plurality of pieces of the device information are associated with the acquired user identification information, determining whether the plurality of pieces of device information include device information of a first display device being a head-mounted device and a second display device not being the head-mounted device; and
selecting a second display mode from among a first display mode being a display mode of the first display device and the second display mode being a display mode of the second display device, and streaming the streaming image corresponding to the streaming request to the first display device or the second display device corresponding to the acquired device information so that the display mode corresponds to the selected second display mode.

9. A non-transitory computer-readable storage medium storing a program for causing a processor installed in a streaming apparatus including a communication unit and a storage unit configured to store, in association with each other, user identification information for identifying a user and device information for identifying a display device used by the user, to execute:
processing of generating a streaming image based on a captured image received from a streamer terminal;
processing of receiving a streaming request;
processing of acquiring user identification information included in the streaming request and device information;
when a plurality of pieces of the device information are associated with the acquired user identification information, processing of determining whether the plurality of pieces of device information include device information of a first display device being a head-mounted device and a second display device not being the head-mounted device; and
processing of selecting a second display mode from among a first display mode being a display mode of the first display device and the second display mode being a display mode of the second display device, and streaming the streaming image corresponding to the streaming request to the first display device or the second display device corresponding to the acquired device information so that the display mode corresponds to the selected second display mode.
